(19) United States
(12) Patent Application Publication
(10) Pub. No.: US 2019/0227865 A1
(43) Pub. Date: Jul. 25, 2019

(54) INFORMATION PROCESSING DEVICE AND INFORMATION PROCESSING METHOD

(71) Applicant: PFU LlMITED, Ishikawa (JP)

(72) Inventors: Yoshiyuki YAMADA, Ishikawa (JP); Osamu MIYAKAWA, Ishikawa (JP); Shigeyuki YOKOUCHI, Ishikawa (JP)

(21) Appl. No.: 15/974,418

(22) Filed: May 8, 2018

(30) Foreign Application Priority Data
Jan. 19, 2018 (JP) 2018-007617

(51) Int. Cl. G06F 11/07

(52) U.S. Cl. CPC G06F 11/0793; G06F 11/079; G06F 11/0751

(57) ABSTRACT

The present invention provides an information processing device comprising: a memory and a processor coupled to the memory and the processor configured to: store a shared module shared by a plurality of software and unique modules unique to each of the respective software; and read out a shared module and a unique module required by designated software from the program storing portion. Also, an information processing device comprising: a memory and a processor coupled to the memory and the processor configured to: store a plurality of modules for structuring software including a self-recovery function; identify a faulty module that has a fault from among modules stored; and perform recovery processing through mutually differing recovery procedures, depending on the faulty module identified.

### CROSS-REFERENCE TO RELATED APPLICATIONS

This application is based on and claims priority under 35 USC 119 from Japanese Patent Application No. 2018-007617 filed Jan. 19, 2018.

### FIELD

The present invention relates to an information processing device, an information processing method, and a computer readable medium.

### SUMMARY OF THE INVENTION

According to an aspect of the invention, there is provided an information processing device comprising: a memory, a non-volatile memory and a processor coupled to the memory and the non-volatile memory, the processor configured to: store, in the non-volatile memory, a shared module shared by a plurality of software and unique modules unique to each of the respective software; and read out, from the non-volatile memory to the memory, a shared module and a unique module required by designated software.

According to another aspect of the invention, there is provided an information processing device comprising: a memory, a non-volatile memory and a processor coupled to the memory and the non-volatile memory, the processor configured to: store, in the non-volatile memory, a plurality of modules for structuring software including a self-recovery function; identify a faulty module that has a fault from among modules stored in the non-volatile memory; and perform recovery processing through mutually differing recovery procedures, depending on the faulty module identified.

According to another aspect of the invention, there is provided an information processing method comprising: writing a shared module shared by a plurality of software and unique modules unique to each of the respective software to a predetermined program recording region; and reading a shared module and a unique module required by designated software from the program recording region.

According to another aspect of the invention, there is provided an information processing method comprising: writing a plurality of modules for structuring software that includes a self-recovery function to a predetermined program recording region; identifying a faulty module that has a fault from among the modules written to the program recording region; and performing recovery processing through mutually differing recovery procedures, depending on the faulty module identified.

According to another aspect of the invention, there is provided a non-transitory computer-readable recording medium storing thereon a computer program that causes a computer to perform a method comprising: writing a shared module shared by a plurality of software and unique modules unique to each of the respective software to a predetermined program recording region; and reading a shared module and a unique module required by designated software from the program recording region.

According to another aspect of the invention, there is provided a non-transitory computer-readable recording medium storing thereon a computer program that causes a computer to perform a method comprising: writing a plurality of modules for structuring software that includes a self-recovery function to a predetermined program recording region; identifying a faulty module that has a fault from among the modules written to the program recording region; and performing recovery processing through mutually differing recovery procedures, depending on the faulty module identified.

### BRIEF DESCRIPTION OF THE DRAWINGS

Exemplary embodiments of the present invention will be described in detail based on the following figures.

FIG. 1 is a diagram illustrating the overall structure of an update processing system 1 for carrying out a firmware update.

FIG. 2 is a diagram illustrating the hardware structure and software structure of the scanner device 300.

FIG. 3A is a diagram illustrating the firmware module structure, and FIG. 3B is a diagram for explaining the data size in the flash ROM and the data size when loaded into memory.

FIG. 4 is a flowchart for explaining the firmware updating processing (S10) for the scanner device 300.

FIG. 5 is a flowchart for explaining processing (S20) by the first CPU 400 (CPU #1).

FIG. 6 is a flowchart for explaining processing (S30) by the second CPU 402 (CPU #2).

FIG. 7A is a diagram illustrating the procedures of the firmware updating processing in a non-faulty state, and FIG. 7B is a diagram illustrating the recovery processing for handling faulty firmware.

FIG. 8A illustrates a procedure in the recovery processing in a Case 1, and FIG. 8B illustrates the procedures in the recovery processing in a Case 2.

FIG. 9A illustrates a procedure in the recovery processing in a Case 3, and FIG. 9B illustrates the procedures in the recovery processing in a Case 4.

FIG. 10 is a diagram for explaining the relationships between the faulty modules and the recovery processing.

### DESCRIPTION OF EMBODIMENTS

In a scanner device or the like where an operating system is installed, a function is installed for carrying out updating of a program for expanding functionality or correcting damage, and program updating is also possible through a wireless connection, such as Wi-Fi, in addition to program updating through a wired connection, such as USB.

However, program updating using a wireless connection is susceptible to the effects of the external environment, and, when compared to a wired connection, the risk that an update will fail due to interrupted communication during data transfer is high.

Because of this, a recovery method is contemplated wherein, if there has been a failure in updating the program through a wireless connection, the method switches to re-execution using boot firmware through a wired connection (Comparative Example 1).

Moreover, when emphasizing operations without a personal computer, it is necessary to carry out recovery using a wireless connection, and a mechanism is contemplated wherein two generations of the main program are stored (Comparative Example 2). In this case, the program update executes updating processing for the version with the older version number, or the program wherein a fault is detected, and the switching of generations is carried out after the updating processing has been completed properly, and thus it is possible to update a program even in the event of multiple failures.

In addition, programs have become much larger than they have been conventionally, due to, for example, the provision of UIs (user interfaces) through touch panel installation. This massive increase in size of programs has caused an increase also in the sizes of storage regions, such as flash ROM for storing programs, and increases the length of time required to load the programs, requiring more time before a device becomes usable.

Note that as a method for shortening the device startup time, it is possible to use a hibernation function (a mechanism wherein the state of memory during operation is backed up and restored in full); however this would necessitate yet another dedicated storage region in addition to that for normal programs.

In this way, this would increase the size of the flash ROM, or the like, for storing programs.

Given this, in the present embodiment, a required size of a program recording region is restrained through structuring software from shared modules, which are shared by a plurality of software, and unique modules, which are unique to individual software.

Moreover, in the present embodiment, recovery methods are prepared that are mutually different depending on the module wherein there is a fault (hereinafter termed a “faulty module”), to achieve recovery of a firmware update failure without storing two generations of the program, as in Comparative Example 2.

### Embodiment

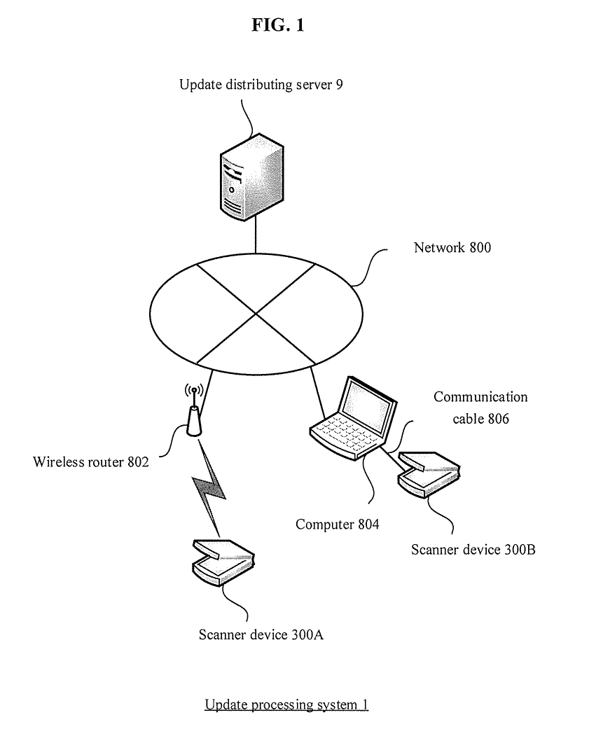

FIG. 1 is a diagram illustrating the overall structure of an update processing system 1 for carrying out a firmware update. Note that in the present embodiment, the explanation will use, as a specific example, a case wherein firmware of a scanner device 300 is updated, as an example of software updating processing.

As illustrated in FIG. 1, the update processing system 1 has a scanner device 300, a wireless router 802, a computer 804, and an update distributing server 9.

The update distributing server 9 is a server device for distributing update files for updating the software. The update distributing server 9 in the present example is connected to a network 800, to distribute update files for updating firmware of the scanner device 300.

The scanner device 300 is connected, through wireless communication, to the network 800 through the wireless router 802, to receive an update file from the update distributing server 9. Moreover, the scanner device 300 is wire-connected through a communication cable 806, such as a USB cable, or the like, to the computer 804 that is connected to the network 800, and receives an update file from the update distributing server 9 through the computer 804.

The network 800 may be the Internet, or may be a local area network (LAN).

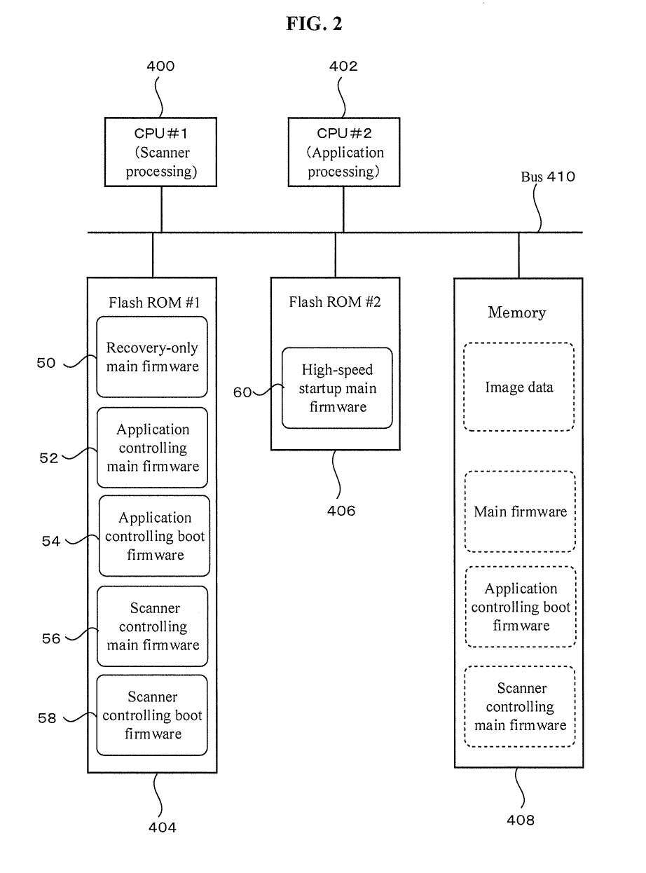

FIG. 2 is a diagram illustrating the hardware structure and software structure of the scanner device 300. The hardware structure in this figure is an information processing device wherein the scanner device 300 is built in, an example of an information processing device according to the present invention.

As illustrated in FIG. 2, the scanner device 300 has a first CPU 400 (CPU #1), a second CPU 402 (CPU #2), a first flash ROM 404 (flash ROM #1), a second flash ROM 406 (flash ROM #2), and a memory 408, and these structures are connected together through a bus 410.

The first CPU 400 (CPU #1) and the second CPU 402 (CPU #2) are, for example, central processing units. In the present example, the first CPU 400 (CPU #1) is assigned to scanner processing and the second CPU 402 (CPU #2) is assigned to application processing.

The first flash ROM 404 (flash ROM #1) and the second flash ROM 406 (flash ROM #2) are non-volatile memories, and function as regions for storing firmware. The second flash ROM 406 is a parallel flash ROM that is more expensive, but has a higher speed of access than the first flash ROM 404, to shorten the time required for loading into memory the high-speed startup main firmware 60, which is stored in the second flash ROM 406, to achieve faster startup. Note that the first flash ROM 404 (flash ROM #1) and the second flash ROM 406 (flash ROM #2) may be referred to in general as “flash ROM.” The flash ROM is an example of a program storing portion according to the present invention.

The memory 408 is, for example, a volatile memory, and functions as a main storage device. In addition to storing image data that is read in during the scanning processing, firmware loaded from the flash ROM is also stored in the memory 408.

As illustrated in FIG. 2, modules for structuring recovery-only main firmware 50, application controlling main firmware 52, application controlling boot firmware 54, scanner controlling main firmware 56, and scanner controlling boot firmware 58 are stored in the first flash ROM 404, and a module for structuring the high-speed startup main firmware 60 is stored in the second flash ROM 406. Note that in the present embodiment, the recovery-only main firmware 50, the application controlling main firmware 52, the application controlling boot firmware 54, the scanner controlling main firmware 56, the scanner controlling boot firmware 58, and the high-speed startup main firmware 60 may be referred to in general to “firmware.”

The “firmware updating processing” in the present embodiment is that of the firmware in the flash ROM being overwritten, and “recovery” is rewriting of the firmware in the flash ROM.

The recovery-only main firmware 50 is firmware for recovery only, wherein the size is reduced through restriction to the minimum required functionality for recovery through Wi-Fi, and incorporates only functions for updating firmware through Wi-Fi.

The application controlling main firmware 52 is main firmware for application control through Wi-Fi functions or through touch panel installation. The application controlling main firmware 52 achieves functions such as startup of the device from a stopped state (cold booting), initialization of various types of drivers such as Wi-Fi drivers, data transfer via Wi-Fi and updating of firmware, and displaying and setting up operating modes through touch panel installation, and the like.

The application controlling boot firmware 54 is boot firmware for achieving application control through Wi-Fi or through touch panel installation. The application controlling boot firmware 54 loads into the memory 408 either the recovery-only main firmware 50, the application controlling main firmware 52, or the high-speed startup main firmware 60, into the memory 408 and then starts either one of these firmware.

The scanner controlling main firmware 56 is main firmware for controlling the scanner device 300, and achieves scanner operations such as motor control of the scanner device 300, reading-in of scanned image data, and the like.

The scanner controlling boot firmware 58 is boot firmware for controlling the scanner device 300. Specifically, the scanner controlling boot firmware 58 loads, into the memory 408, the application controlling boot firmware 54 and the scanner controlling main firmware 56 and then starts these firmware. Moreover, the scanner controlling boot firmware 58 executes a checksum on the application controlling main firmware 52.

The scanner controlling boot firmware 58 selects the main firmware to be started (specifically, the recovery-only main firmware 50 or the application controlling main firmware 52), and provides notification to the application controlling boot firmware 54 to launch the main firmware that has been selected. If the application controlling main firmware 52 is not corrupted, the scanner controlling boot firmware 58 in the present example selects and starts the application controlling main firmware 52, but if the application controlling main firmware 52 is corrupted, the scanner controlling boot firmware 58 selects and starts the recovery-only main firmware 50.

The high-speed startup main firmware 60 is firmware for high-speed startup in order to operate the scanner device 300 through Wi-Fi, and performs startup using a hibernation function in order to start more quickly than through the application controlling main firmware 52.

Note that the firmware loading into the memory 408 uses DMA transfer, but the firmware startup for operation by the CPU #2 can be made faster through the use of high-speed DMA transfer in transferring the recovery-only main firmware 50, the application controlling main firmware 52, and the high-speed startup main firmware 60.

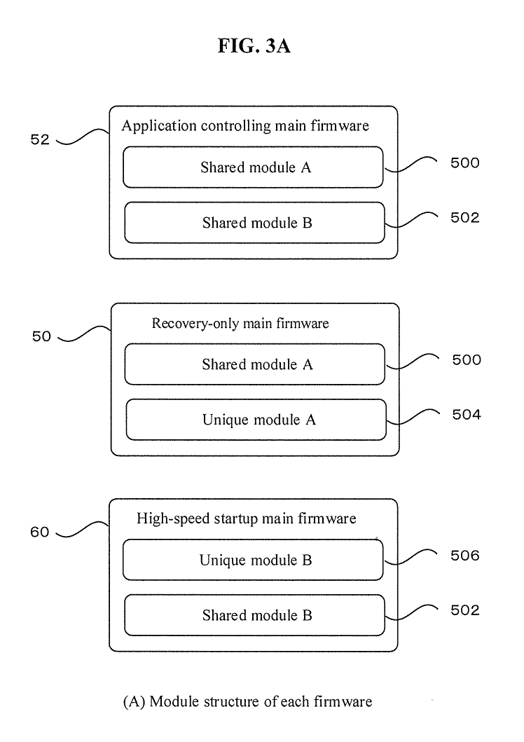

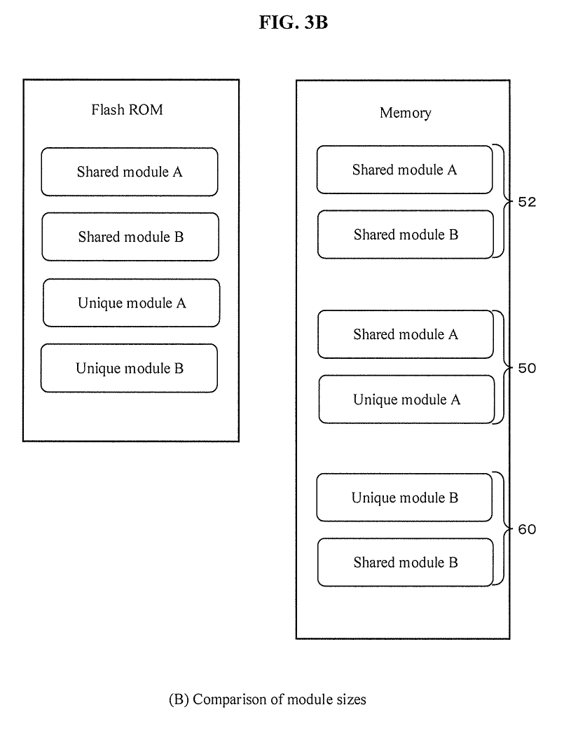

FIG. 3A is a diagram illustrating the firmware module structure, and FIG. 3B is a diagram for explaining the data size in the flash ROM and the data size when loaded into memory.

As illustrated in FIG. 3A, the application controlling main firmware 52 is structured from a shared module A500 and a shared module B502. The shared module A500 is a program module shared by the application controlling main firmware 52 and the recovery-only main firmware 50. Moreover, the shared module B502 is a program module shared by the application controlling main firmware 52 and the high-speed startup main firmware 60.

The recovery-only main firmware 50 is structured from a shared module A500, and a unique module A504. The unique module A504 is a program module unique to the recovery-only main firmware 50.

The high-speed startup main firmware 60 is structured from a unique module B506 and the shared module B502. The unique module B506 is a program module unique to the high-speed startup main firmware 60.

When the application controlling boot firmware 54, the application controlling main firmware 52, the recovery-only main firmware 50, or the high-speed startup main firmware 60 is loaded into the memory 408, the required shared modules and unique modules are read out from the flash ROM. In this case, the application controlling boot firmware 54 is an example of a module reading portion according to the present invention.

As illustrated in FIG. 3B, the shared modules and the unique modules that are read out from the flash ROM are loaded into the memory 408, and these are combined to operate as the application controlling main firmware 52, the recovery-only main firmware 50, or the high-speed startup main firmware 60.

The shared module A500 is, for example, a Linux (registered trademark) kernel, and is 4 MB. The shared module B502 is, for example, a full-function Root FS, and is 54M. The unique module A504 is, for example, a recovery-only Root FS, and is 10 MB. The unique module B506 is, for example, a Linux (registered trademark) kernel, and a high-speed startup-only Root FS of 21 MB.

When the application controlling main firmware 52, the recovery-only main firmware 50, and the high-speed startup main firmware 60 are loaded into the memory 408, they total 147 MB, but through organizing into shared modules and the unique modules, they can be reduced to 89 MB in the flash ROM.

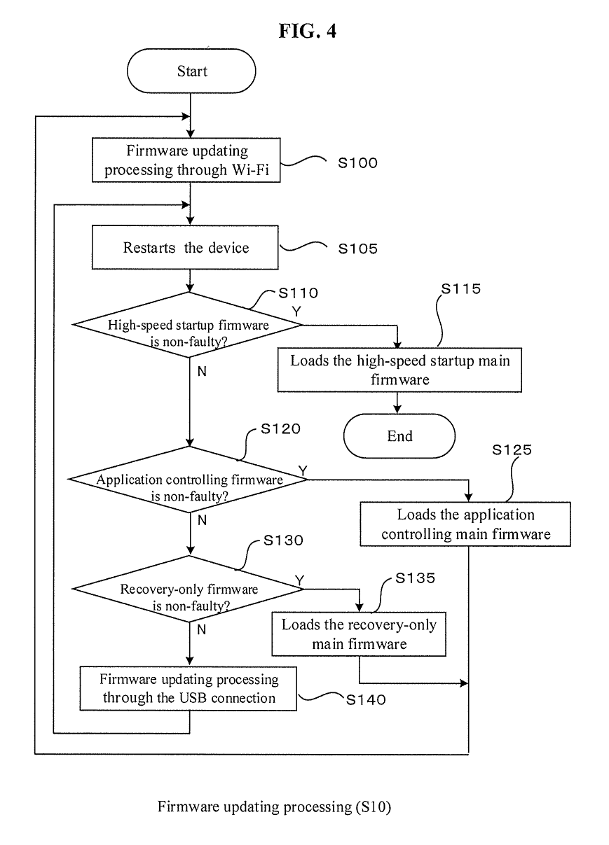

FIG. 4 is a flowchart for explaining the firmware updating processing (S10) for the scanner device 300.

As illustrated in FIG. 4, in Step 100 (S100), the scanner device 300 accesses the update distributing server 9 through the wireless router 802, to execute the firmware updating processing. The updated firmware is the entire firmware, with the exception of the scanner controlling boot firmware 58.

In Step 105 (S105), the scanner device 300 restarts the device.

In Step 110 (S110), the scanner controlling boot firmware 58 of the scanner device 300 carries out a summation check on the high-speed startup main firmware 60 of the flash ROM to determine whether or not the high-speed startup main firmware 60 is non-faulty. In this case, the scanner controlling boot firmware 58 is an example of a fault identifying portion according to the present invention.

If, in the scanner device 300, the determination is that the high-speed startup main firmware 60 is non-faulty, the processing moves to S115, but if the determination is that the high-speed startup main firmware 60 is corrupted, the processing moves to S120.

In Step 115 (S115), the application controlling boot firmware 54 loads the high-speed startup main firmware 60 from the flash ROM to the memory 408, and the processing is completed.

In Step 120 (S120), the scanner controlling boot firmware 58 carries out a summation check on the application controlling main firmware 52 of the flash ROM to determine whether or not the application controlling main firmware 52 is non-faulty.

In the scanner device 300, if the determination is that the application controlling main firmware 52 is non-faulty, the processing moves to S125, but if the determination is that the application controlling main firmware 52 is corrupted, the processing moves to S130.

In Step 125 (S125), the application controlling boot firmware 54 loads the application controlling main firmware 52 from the flash ROM to the memory 408, and processing returns to S100.

In Step 130 (S130), the scanner controlling boot firmware 58 carries out a summation check on the recovery-only main firmware 50 of the flash ROM to determine whether or not the recovery-only main firmware 50 is non-faulty.

In the scanner device 300, if the determination is that the recovery-only main firmware 50 is non-faulty, the processing moves to S135, but if the determination is that the recovery-only main firmware 50 is corrupted, the processing moves to S140.

In Step 135 (S135), the application controlling boot firmware 54 loads the recovery-only main firmware 50 from the flash ROM to the memory 408, and processing returns to S100.

In Step 140 (S140), the scanner controlling boot firmware 58 carries out the firmware updating processing through the USB connection, and processing returns to S105.

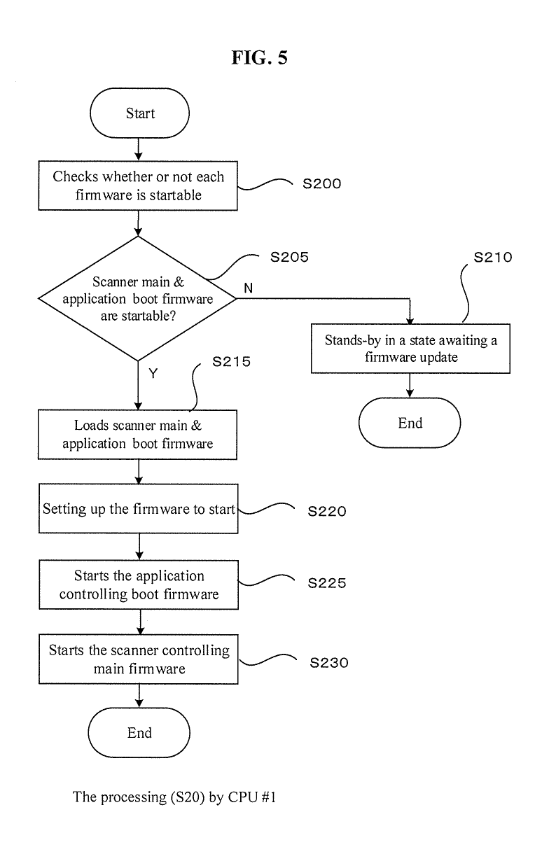

FIG. 5 is a flowchart for explaining processing (S20) by the first CPU 400 (CPU #1).

As illustrated in FIG. 5, in Step 200 (S200), the scanner controlling boot firmware 58 checks whether or not each firmware is startable.

In Step 205 (S205), if the scanner controlling boot firmware 58 has determined that the scanner controlling main firmware 56 and the application controlling boot firmware 54 are startable, the processing moves to S215, but otherwise the processing moves to S210.

In Step 210 (S210), the scanner controlling boot firmware 58 stands-by in a state awaiting a firmware update through the USE connection.

In Step 215 (S215), the scanner controlling boot firmware 58 loads, into the memory 408, the scanner controlling main firmware 56 and the application controlling boot firmware 54.

In Step 220 (S220), the scanner controlling boot firmware 58 selects the firmware to start, from among the high-speed startup main firmware 60, the application controlling main firmware 52, and the recovery-only main firmware 50, and notifies the application controlling boot firmware 54 of the selection result.

In the Step 225 (S225), the scanner controlling boot firmware 58 starts the application controlling boot firmware 54 that has been loaded.

In Step 230 (S230), the scanner controlling boot firmware 58 starts the scanner controlling main firmware 56 that has been loaded.

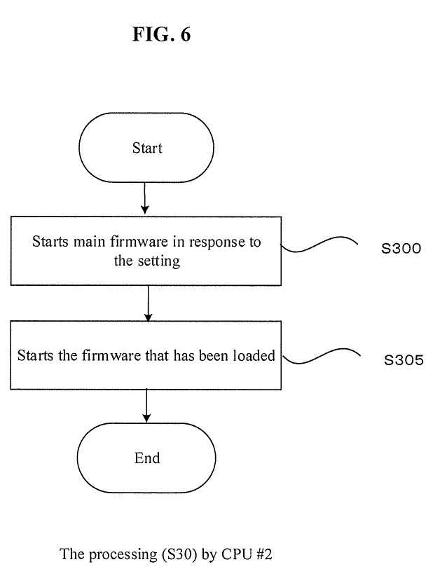

FIG. 6 is a flowchart for explaining processing (S30) by the second CPU 402 (CPU #2).

As illustrated in FIG. 6, in Step 300 (S300), the application controlling boot firmware 54 loads, into the memory 408, the high-speed startup main firmware 60, the application controlling main firmware 52, or the recovery-only main firmware 50, in response to the notification from the scanner controlling boot firmware 58.

In Step 305 (S305), the application controlling boot firmware 54 starts the high-speed startup main firmware 60, the application controlling main firmware 52, or the recovery-only main firmware 50 that has been loaded.

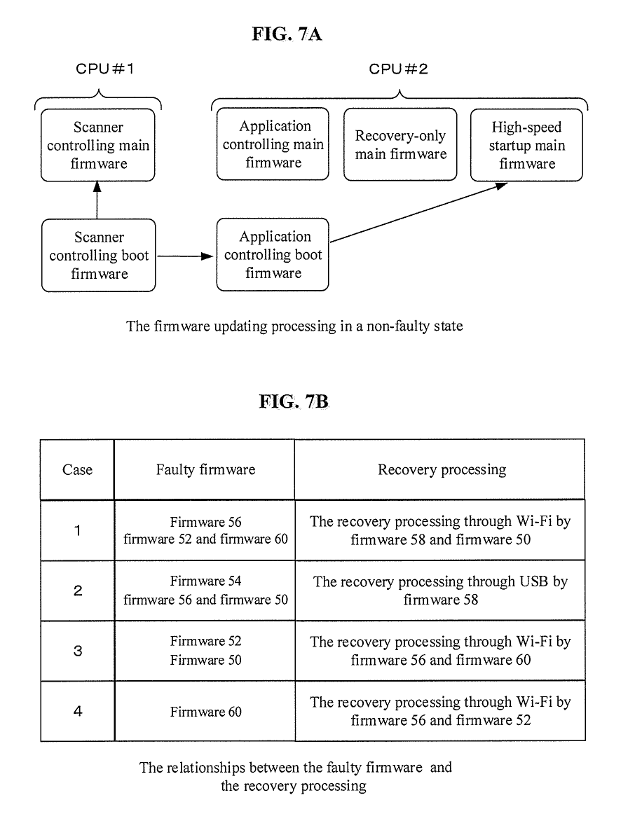

FIG. 7A is a diagram illustrating the procedures of the firmware updating processing in a non-faulty state, and FIG. 7B is a diagram illustrating the recovery processing for handling faulty firmware.

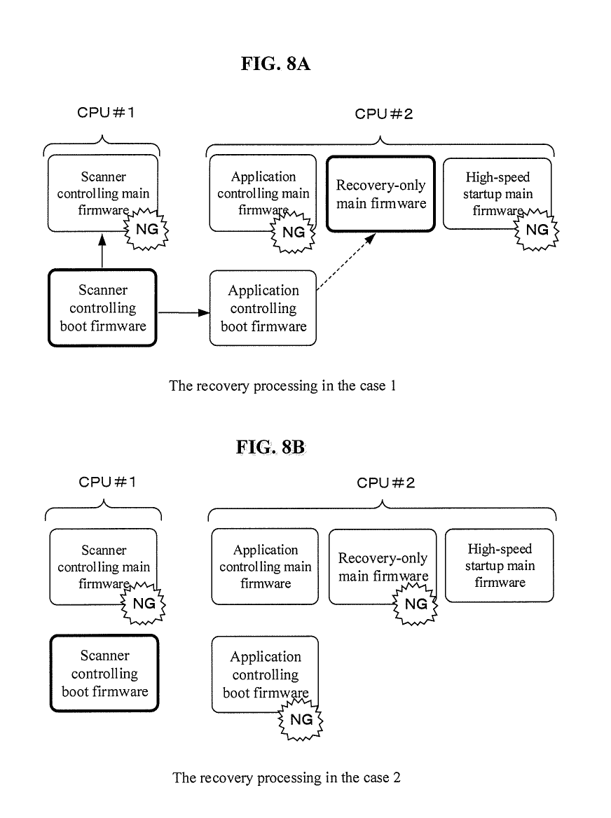

FIG. 8A illustrates a procedure in the recovery processing in a Case 1, and FIG. 8B illustrates the procedures in the recovery processing in a Case 2.

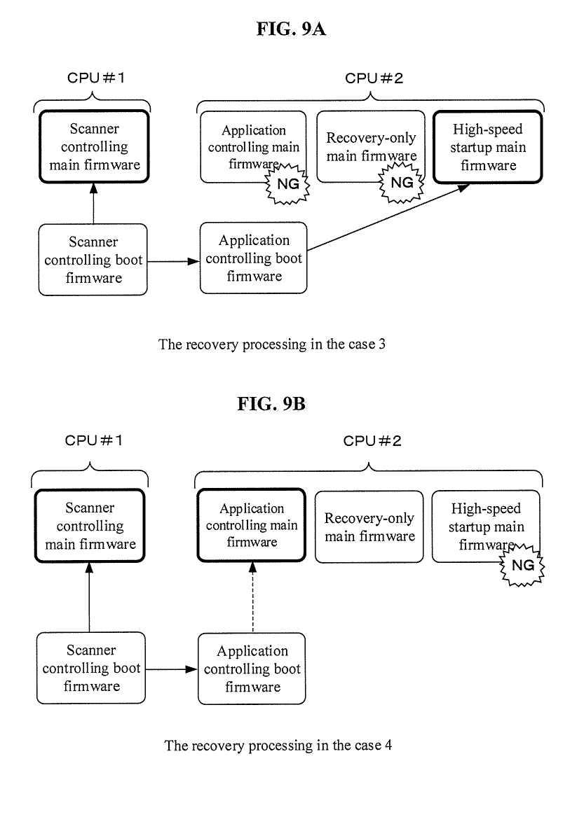

FIG. 9A illustrates a procedure in the recovery processing in a Case 3, and FIG. 9B illustrates the procedures in the recovery processing in a Case 4.

In the non-faulty state, as illustrated in FIG. 7A, the scanner controlling boot firmware 58 loads the scanner controlling main firmware 56 into the memory 408 and then starts the firmware, and loads the application controlling boot firmware 54 into the memory 408 and then starts the firmware. In response to this, the application controlling boot firmware 54 loads, into the memory 408, the high-speed startup main firmware 60 and then starts the firmware.

If the application controlling main firmware 52 and the high-speed startup main firmware 60, or the scanner controlling main firmware 56, is the faulty firmware (Case 1), then, as illustrated in FIG. 8A, the scanner controlling boot firmware 58 loads, into the memory 408, the application controlling boot firmware 54 and then starts the firmware, and the application controlling boot firmware 54 loads the recovery-only main firmware 50 into the memory 408 to execute the recovery processing.

If the scanner controlling main firmware 56 and the recovery-only main firmware 50, or the application controlling boot firmware 54, is the faulty firmware (Case 2), then, as illustrated in FIG. 8B, the scanner controlling boot firmware 58 executes the recovery processing using the USB connection.

If the recovery-only main firmware 50 or the application controlling main firmware 52 is the faulty firmware (Case 3), then, as illustrated in FIG. 9A, the scanner controlling boot firmware 58 loads, into the memory 408, the scanner controlling main firmware 56 and the application controlling boot firmware 54, and the application controlling boot firmware 54 loads the high-speed startup main firmware 60 into the memory 408. The scanner controlling main firmware 56 and the high-speed startup main firmware 60 execute the recovery processing through Wi-Fi.

If the high-speed startup main firmware 60 is the faulty firmware (Case 4), then, as illustrated in FIG. 9B, the scanner controlling boot firmware 58 loads, into the memory 408, the scanner controlling main firmware 56 and the application controlling boot firmware 54, and the application controlling boot firmware 54 loads the application controlling main firmware 52 into the memory 408. The scanner controlling main firmware 56 and the application controlling main firmware 52 execute the recovery processing through Wi-Fi.

In this way, by using mutually differing methods, a plurality of firmware for carrying out the recovery processing, and firmware for carrying out processing other than the recovery processing are written to the flash ROM.

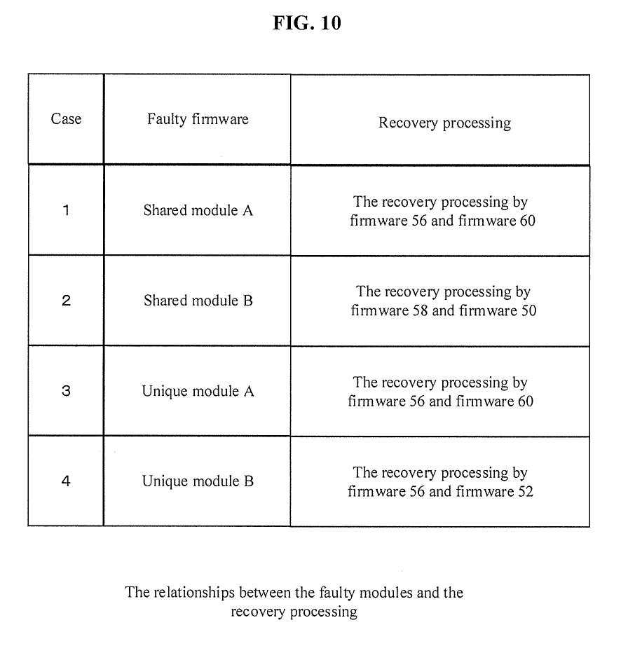

FIG. 10 is a diagram for explaining the relationships between the faulty modules and the recovery processing.

In the present embodiment, the firmware is structured through combinations of the shared modules or the unique modules, and thus if a shared module is corrupted, then two or more firmware will be faulty firmware. Consequently, as illustrated in FIG. 10, it can be said that the scanner controlling boot firmware 58 switches the method for the recovery processing depending on which of the modules that structure the firmware is faulty.

As explained above, the scanner device 300 according to the present embodiment switches the firmware used in the recovery depending on which of the firmware is faulty. For example, if the application controlling boot firmware 54 is the faulty firmware, then the application controlling main firmware 52, the recovery-only main firmware 50, and the high-speed startup main firmware 60, which have Wi-Fi functions, cannot be loaded, and thus the scanner controlling boot firmware 58 executes the update using the USB connection.

Moreover, through structuring a plurality of firmware through the shared modules or the unique modules, the scanner device 300 is able to reduce the size of the flash ROM for storing these firmware.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a memory;
a non-volatile memory; and
a processor coupled to the memory and the non-volatile memory, the processor configured to:
store, in the non-volatile memory, a shared module shared by a plurality of software and unique modules unique to each of the respective software; and
read out, from the non-volatile memory to the memory, a shared module and a unique module required by designated software.

2. An information processing device comprising:
a memory;
a non-volatile memory; and
a processor coupled to the memory and the non-volatile memory, the processor configured to:
store, in the non-volatile memory, a plurality of modules for structuring software including a self-recovery function;
identify, a faulty module that has a fault, from among modules stored in the non-volatile memory; and
perform recovery processing through mutually differing recovery procedures, depending on the faulty module identified.

3. The information processing device according to claim 1, wherein
the information processing device is incorporated in a scanner device; and
the software is firmware of the scanner device.

4. The information processing device according to claim 1, wherein
the plurality of software include software for achieving a software recovery function, and software for achieving a function other than the recovery function.

5. The information processing device according to claim 2, wherein
the processor is further configured to:
store, in the non-volatile memory, at least a module for wired communication and a module for wireless communication; and
execute, upon determination that either one of the module for wired communication or the module for wireless communication is the faulty module, the recovery processing using the other module.

6. A information processing method comprising:
writing, a shared module shared by a plurality of software and unique modules unique, to each of the respective software to a predetermined program recording region; and,
reading, from the program recording region, a shared module and a unique module required by designated software.

7. A information processing method comprising:
writing, a plurality of modules for structuring software that includes a self-recovery function, to a predetermined program recording region;
identifying, from among the modules written to the program recording region, a faulty module that has a fault; and,
performing recovery processing through mutually differing recovery procedures, depending on the faulty module identified.
